(19) United States
(12) Patent Application Publication
(10) Pub. No.: US 2010/0227164 A1
(43) Pub. Date: Sep. 9, 2010

(54) Fibre-Reinforced Film, Process for Producing the Same, and Use for Food Packaging

(75) Inventors: Esa Hihnala, Lohja (FI); Marko Uosukainen, Virkkala (FI)

Correspondence Address: FISH & RICHARDSON P.C., P.O. BOX 1022, MINNEAPOLIS, MN, 55440-1022, US

(73) Assignee: Visko Teepak Belgium NV, Lommel (BE)

(21) Appl. No.: 12/223,182

(22) PCT Filed: Jan. 29, 2007
(86) PCT No.: PCT/FI2007/050048

§ 371 Date: Aug. 28, 2008

(30) Foreign Application Priority Data
Feb. 10, 2006 (FI) 20065096

(51) Int. Cl. B32B 29/06; B32B 5/00; B05D 3/10; B05D 3/12; D21H 17/30

(52) U.S. Cl. 428/340; 427/340; 427/289

(57) ABSTRACT

The present invention is directed to a fibre-reinforced film comprising a paper-reinforced alginate film containing polyhydric alcohol. Further, the invention is directed to a process for producing the fibre-reinforced film, and the use thereof for packaging food products, particularly meat products to be cooked and smoked.

### FIELD OF THE INVENTION

The present invention is directed to a fibre-reinforced film comprising a paper-reinforced alginate film containing polyhydric alcohol. Further, the invention is directed to a process for producing the fibre-reinforced film, and the use of such a fibre-reinforced film for packaging food products, particularly for packaging meat products to be cooked and smoked.

### PRIOR ART

Package wrappings are employed for encasing food products processed to various degrees such as meat, fish and vegetable products. Package wrappings are not only used to protect finished products, but also for various processing steps to prevent the food products from falling apart, for colouring, or flavouring thereof, for instance in sausage production and around whole meat products during smoking and cooking stages. Package wrappings may be left on the processed food product, thus forming an edible part of the food product, or removed prior to further processing and/or packaging of the food product, or only immediately prior to consumption of the food product.

Edible package wrappings of the prior art include films made of collagen, modified cellulose, and carrageen. As for package wrappings to be peeled off, examples thereof include fibre-reinforced casings, paper wrappings, cellophane and plastic casings. Said wrappings may be impregnated or coated with various seasonings, colours, and agents facilitating handling thereof in various processing steps of the food products, particularly with peeling aids for wrappings to be peeled off. The wrapped product may also be introduced into a separate net for stabilization of the package, and for shaping of the product.

Collagen films are most common edible food package wrappings, described for instance in patent publications U.S. Pat. No. 3,123,653 and U.S. Pat. No. 3,535,125. Said collagen films consist of edible collagen plasticized for instance with glycerol or other polyols, followed by extrusion to give a film, and finally drying with heat. Collagen films are typically used as wrappings of hams to be cooked, which are often further encased in a net. During cooking, the film melts on the ham surface to form an edible layer, from which the net may be removed relatively easily. Originating from animals, either from bovine or pork, collagen is not an acceptable wrapping for all consumers due to dietary or religious reasons. Moreover, permeability of collagen films is poor, thus giving rise to formation of air pockets under the film during cooking of the food products encased in such films. Due to poor tear resistance, collagen films may not be perforated, and damage thereof easily causes tearing. Also thickness of collagen films results in unclear net patterns forming on food products encased in said films and nets. There have been attempts to develop alternative solutions to collagen films, both for package wrappings to be consumed with the food product and wrappings to be peeled off.

Films made of modified cellulose such as modified hydroxypropyl methyl cellulose are mostly soluble in water, and for this reason, such films are hardly used for packaging meat products.

U.S. Pat. No. 6,730,340 discloses a solution to be used for the production of films based on carrageenan/Konjac/Gellan, useful for the production of hams and sausages as substitutes for collagen films, and further, films produced from this solution, said films also comprising starch and alginate such as polypropylene glycol, sodium or calcium alginate, and glycerol. Adhesion of the film to the meat product is said to be improved by starch and alginate, glycerol being used to improve the elasticity of the film. The film sticks to the meat product to be cooked, and will be consumed with the product as the collagen film. No mention is made about the suitability of the film for use with a net.

Patent publication US 2003/054075 A1 describes an impregnated, porous, permeable absorbent paper or cellophane, process for its production, method for distributing colour and flavour of liquid smoke to food products, and a product for heat treatment of a food product. The paper or cellophane is impregnated with peeling aids and optionally with liquid smoke and/or other flavoring or colouring agents for food products, to be used as a substitute for collagen and cellulose casings for producing flavoured and coloured food products, particularly hams to be cooked having a smoky taste. The paper contains cellulose fibres in combination with synthetic and/or hemp fibres, having a measured basis weight of at least 12.3 g/m², typically from 25 to 65 g/m². In addition to paper and cellophane, sufficiently absorbent and elastic fabrics are also said to be useful. Lecithin, lecithin in combination with alginates, alginic acid, chitosan, casein, wax, fat and vegetable oil, water-soluble cellulose ethers alone or in combination with lecithine, as well as alkyl ketene dimer are mentioned as peeling aids. Said document further teaches that it is preferable to coat the surface of the treated paper not contacting the food product with a coating or a film impermeable to humidity, vapour and/or oxygen to increase the shelf life of the food product. Use of glycerol or other polyhydric alcohols for paper treatment is not suggested.

Patent publication EP 1 203 733 B1 describes a packaging wrapper in the form of a flat film, particularly suitable for scalded hams or scalded and pickled products, said wrapper being insoluble in water and consisting of a film permeable to gases, steam and/or smoke, and further, a process for producing a package wrapper. Said film may be impregnated with liquid seasonings, and a separate net may be drawn on the meat product packed in said film. The film comprises a thin fibre film having an anti-adhesive coating of e.g. viscose, silicone, wax, or polyethylene on the side facing the meat product. Basis weight of the fibre film is said to be about 3 to 80 g/m², particularly from 8 to 20 g/m². The fibre film is said to consist of cellulose fibre or synthetic fibre or a mixture thereof, such as cellulose, staple fibre, cotton, polyethylene, polypropylene and/or polyamide, said fibres being processed to a woven, knitted, fleece, or non-woven material. The fibre film may be used for transferring colour to the food product encased therein by printing edible colour on the anti-adhesive coating, an adhesive consisting of proteins, starch, or mixtures of the two, such as a mixture of soy protein and glycerin, being applied between the colour and coating for the adhesion of the two.

U.S. Pat. No. 5,143,584 describes a paper useful as a fibre reinforcement of a cellulose-based packaging film, particularly a tubular sausage casing, a process for producing the paper, and a packaging film. The paper contains alginic acid and/or alginate substantially insoluble in water, particularly alkaline earth metal alginate such as calcium alginate, in an amount of 0.5 to 50% by weight of the total paperweight. The basis weight of the paper is said to be 12 to 30 g/m², preferable basis weight being 15 to 28 g/m², the paper consisting of hemp fibres. During paper making, the alginate may be added directly to the pulp in a water-soluble form, followed by formation of the sheets and partial or total drying thereof; or totally or partially dried cellulose paper sheets are impregnated by immersing in an aqueous solution of a water-soluble salt of the alginic acid, or by spraying the solution on the paper; or alternatively, water-soluble alginate is both added to the pulp and used for impregnation of the formed sheets, followed finally by conversion of the alginate to a form substantially insoluble in water by an acid treatment, or by adding water-soluble salts of bi- or trivalent cations, for instance calcium chloride. For certain paper grades, coating and impregnation agents known in the papermaking art such as polyamine-polyamide/epichlorohydrin resins may be added to the cellulose fibre suspension prior to or after sheet formation. Addition of other agents to the paper is not mentioned. The cellulose film using this paper as the fibre-reinforcement is produced by known alkali viscose process. Use of the paper as teabags is also mentioned.

U.S. Pat. No. 5,419,962 describes a porous fibrous sheet material corresponding to a base paper bonded with dilute viscose, for use in the manufacture of fibre-reinforced food casings, said material being compressed and treated with up to 10% by weight of a non-viscose bonding agent, said document further disclosing a food casing fibre-reinforced with said paper. The treatment with the bonding agent will not prevent the casing forming material from penetrating into the paper, but the treated paper will still be porous. The paper to be treated may consist of cellulose fibres, such as hemp fibres, optionally also containing other natural fibres such as sisal, and synthetic fibres such as rayon. The treatment may comprise two steps, first the immersion of the paper into a film-forming substance such as sodium alginate, drying, followed by immersion into a cross-linking agent such as calcium chloride, so that the bonding agent comprises up to 10% by weight, typically 0.5 to 8% by weight of the paper. Basis weight of the paper is said to be about 15 to 35 g/m². Use of glycerol or other polyhydric alcohols for paper treatment is not suggested.

The consumer not only expects the food product to be flawless, but also to fulfill his or her own wishes. Demand for specifically tailored food products is increasing, and more and more attention is directed to the combination of the taste and appearance such as colour and shape properties of the product. For those food products, which are visible at the time of buying, such as food products in trans-parent packages or clerk-served food products at retail, the appearance of the product is one of the most significant sales promoting factors. Both the taste and the appearance of a wrapped product are influenced by wrappings, also by those to be peeled off.

Wrappings that are too thick or unelastic may not be uniformly applied on the food product, and folds formed by the wrapping press deep grooves and clefts onto the food product encased therein, said grooves and clefts becoming visible only after removal of the wrapping. This is a problem particularly in case of smoked food products and other products to be coloured by transferring colour onto the product surface from wrappings impregnated with a colour, or through the wrappings, since the surface of the product then remains unevenly coloured and very speckled. The desired final result is not attained with such wrappings even in combination with a net, since such wrappings are not sufficiently elastic for allowing formation of a distinct net pattern on the product, desirable for the appearance. Thinner wrappings are usually more elastic, thus lying more evenly on the food product, and accordingly, providing a more even colouring result, and further, when used in combination with a net, allowing formation of a distinct net pattern on the product. However, resistance properties of very thin wrappings are not sufficient to allow for easy peeling thereof from the product without disintegrating. Unelastic or too thin wrappings cause problems already during the packaging stage of the food product, and they may even break down, thereby resulting in low number of acceptably packaged products.

On the basis of the above, it may be seen that there is an obvious need for a novel wrapping suitable for packaging food products, said wrapping having elasticity, permeability and resistance properties allowing packaging of food products of different shapes and different types, to be processed in various ways, and being easily removed by peeling from the food product.

### OBJECTS OF THE INVENTION

An object of the invention is to provide a novel fibre-reinforced film particularly suitable for use as a package wrapping.

An object of the invention is also to provide a process for producing a fibre-reinforced film.

Further, an object of the invention is the use of a fibre-reinforced film as a package wrapping for packaging food products, particularly meat products to be cooked and smoked.

Characteristic features of the inventive fibre-reinforced film, process for producing a fibre-reinforced film, and the use thereof for packaging food products are presented in the claims.

### SUMMARY OF THE INVENTION

The present invention relates to a novel fibre-reinforced film comprising a paper-reinforced alginate film containing polyhydric alcohol. In the process for producing the fibre-reinforced film of the invention, paper is impregnated with an impregnating solution comprising alginic acid or a water-soluble salt thereof, a polyhydric alcohol and water, followed by removing the excess impregnating solution, treating both surfaces of the impregnated paper with an aqueous solution of a salt comprising bivalent cations for cross-linking the alginic acid or the water-soluble salt thereof, and finally, drying the paper thus treated.

Due to its elasticity, permeability and resistance properties, the fibre-reinforced film of the invention is excellently suitable for packaging food products like meat, fish, poultry, vegetable, cheese or cheese type products, particularly for packaging meat products to be cooked and smoked, said film being peelable without residues of the film remaining on the food product surface, or without any food product sticking on the peeled film.

Prior to packaging of the food product, the fibre-reinforced film to be used as the wrapping is wetted with water, or alternatively with an aqueous solution containing flavouring and colouring agents, and further, solid particles to be transferred to the food product surface may be applied or attached to the food-contacting film surface. Moreover, a net may be drawn on the packaged food product resulting in a net-like pattern thereon, clearly visible after removal of the net and the fibre-reinforced film.

The invention is now illustrated by a detailed description and examples, not to be considered as limiting the scope thereof.

### DETAILED DESCRIPTION

It has now been surprisingly found that problems of the prior art solutions may be avoided or at least substantially reduced by the procedure of the invention. The invention is based on the finding that a fibre-reinforced film having excellent resistance and elasticity properties, and particularly suitable for packaging food products, is obtained by impregnating a thin, porous paper containing natural material having long fibres with an aqueous solution comprising alginic acid, or a water-soluble salt thereof, and polyhydric alcohol, followed by conversion of said alginate to a film across the total thickness of the paper using an aqueous solution of a salt giving bivalent cations. Being elastic, the fibre-reinforced film is well conformed to the surface of the food product to be packaged, and no wrinkles and particularly no colour defects to products to be coloured are produced on the food product surface by the film, and on the other hand, in case the food product packaged in the fibre-reinforced film is inserted in a net, said film is sufficiently elastic to provide a distinct net pattern on the food product. Elasticity is still increased by wetting the film prior to packaging. Due to the impregnation treatment and resistance properties, the fibre-reinforced film of the invention may be easily peeled off and removed from the food product surface without residues of the film remaining thereon, or without any food product sticking on the peeled film.

The fibre-reinforced film of the invention comprises a paper-reinforced alginate film containing polyhydric alcohol. To achieve sufficient elasticity and permeability, the paper used for the fibre-reinforced film should be thin and porous. Thus the basis weight of the paper to be used for the fibre-reinforced film of the invention is no more than about 80 g/m². This allows for sufficient penetration of the impregnating solution into the paper, and further, formation of an alginate film across the total thickness of the paper. On the other hand, in spite of the thinness of the paper, a fibre-reinforced film having acceptable resistance properties may be obtained by the treatment described above only from paper material with long fibres, without breakdown of the film during the packaging step, or while peeling from the product surface. For this reason, the paper used for the fibre-reinforced film of the present invention comprises at least one natural material having long fibres, such as hemp fibres, e.g. Musa textilis fibres also known as abaca fibres. In this case, the basis weight of the paper is up to 80 g/m², preferably ranging between 8 and 40 g/m², more preferably between 12 and 20 g/m². Particularly good results are obtained with papers having basis weights of about 15 g/m². In addition to or instead of the material with long fibres, the paper may comprise between 5 and 100% of at least one woodpulp fibre, such as chemical pulps made of pine or birch woods. Particularly preferably, said paper comprises abaca fibres.

The proportion of paper in the finished fibre-reinforced film is no more that about 70% by weight, preferably up to 50%, particularly preferably up to about 40%, by weight.

The alginate film is obtained by cross-linking the alginic acid or a water-soluble salt thereof or a mixture of the two used to impregnate the paper, performing said cross-linking with an aqueous solution of a salt having bivalent cations to give an alginate film covering the whole paper across the total thickness thereof. Said water-soluble salt of the alginic acid may be sodium, potassium, or ammonium alginate, preferably sodium alginate. The salt with bivalent cations may for instance be calcium chloride, calcium acetate, or calcium stearate, preferably calcium chloride.

Said fibre-reinforced film comprises between 1 and 40%, preferably between 15 and 25%, and particularly preferably from 18 to 22%, by weight, of a polyhydric alcohol. Said polyhydric alcohol may be selected from the group consisting of glycerol, sorbitol, mannitol, galactitol, arabitol, erythritol, xylitol, and the mixtures thereof, the polyhydric alcohol preferably being glycerol.

Further, the fibre-reinforced film may comprise flavouring and/or colouring agents, coatings or perforations, or solid particles like peppers, paprika, mustard seeds or breadcrumbs. Moreover, said fibre-reinforced film may comprise an emulgator.

Depending on the drying step of the production method, the fibre-reinforced film of the invention may contain residual humidity typically in an amount varying from 10 to 40%, preferably from 15 to 30%, particularly preferably from 18 to 20%, by weight.

Wet strength of the fibre-reinforced film of the invention is typically at least 600 N/m, preferably at least 650 N/m, in the longitudinal direction, the wet strength in the crosswise direction being typically at least 500 N/m, preferably at least 550 N/m.

In the process of the invention for producing a fibre-reinforced film, a paper is impregnated with an impregnating solution comprising alginic acid or a water-soluble salt thereof, polyhydric alcohol, and water, followed by removing the excess impregnating solution, treating both surfaces of the impregnated paper with an aqueous solution of a salt yielding bivalent cations to cross-link the alginic acid or a water-soluble salt thereof, and finally drying the paper thus treated, thereby obtaining a fibre-reinforced film comprising a paper-reinforced alginate film containing polyhydric alcohol.

Above teachings concerning the paper useful for the fibre-reinforced film of the invention are also valid with respect to the paper to be used in the process of the invention.

The water-soluble salt of the alginic acid present in the impregnating solution may be sodium, potassium, or ammonium alginate. Sodium alginate is preferably used.

The impregnating solution may also comprise a mixture of said salts, or alginic acid in an admixture with said salts. Concentration of alginic acid or a water-soluble salt thereof in the impregnating solution varies between 0.1 to 10%, by weight, said concentration being preferably between 1.5 and 4%, by weight. The water used in the process may be ordinary tap water.

The concentration of polyhydric alcohol in the impregnating solution to be used in the process of the invention is such that the finished fibre-reinforced film is provided with a content of the polyhydric alcohol ranging between 1 and 40%, preferably between 15 and 25%, and particularly preferably between 18 and 22%, by weight. Typically, the concentration of the polyhydric alcohol in the impregnating solution ranges from 5 to 20%, by weight. Said polyhydric alcohol may be selected from the group consisting of glycerol, sorbitol, mannitol, galactitol, arabitol, erythritol, xylitol, and mixtures thereof, the polyhydric alcohol being preferably glycerol.

In addition, the impregnating solution may comprise various flavouring and/or colouring agents, such as smoke flavour and caramel colour. The impregnating solution may further contain minor amounts of an emulgator such as Polysorbate 80. An emulgator is used if necessary for the addition of flavouring and colouring agents. The amount of the emulgator in the impregnating solution is typically below 1%.

The salt with bivalent cations may be calcium chloride, calcium acetate, or calcium stearate, said salt being preferably calcium stearate, the concentration thereof in the aqueous solution being between 1 and 10%, preferably between 4 and 8%, by weight.

The excess impregnating solution may be removed by any known procedure, for instance by pressing with compressing cylinders, or by wiping. The aqueous solution of the salt with bivalent cations may be contacted with the paper for instance by spraying on both paper surfaces, or by passing the impregnated paper into a bath containing said solution. Drying may be performed for instance by heated circulated air, by heated cylinders, or by infrared radiation, and the combinations thereof. Drying aims at a residual humidity ranging from 10 to 40%, preferably from 15 to 30%, particularly preferably from 18 to 20%, by weight. In practice, this is achieved by sufficient air circulation, and by a temperature ranging e.g. approximately from 50 to 100° C.

In the process of the invention, the paper to be impregnated may be in the form of sheets. Alternatively, according to an embodiment of the process of the invention, the paper in the form of a web or bent to a tubular form is impregnated by passing into a bath containing the impregnating solution, or by spraying the impregnating solution at least on one surface of the paper, followed by removing the excess impregnating solution, spraying an aqueous solution of a salt with bivalent cations on both surfaces of the paper, and finally drying and reeling the web to form a roll, or cutting to give sheets.

The weight gain of the fibre-reinforced film produced by the process of the invention is typically at least 100%, even more than 200% relative to the weight of the paper therein. Weight gains between 50 and 250% are normal.

Said fibre-reinforced film may subsequently be subjected to any post-treatment procedure known in the art, for instance to coating of one or both surfaces with one or more layer(s) of a material acceptable in the field of application of the fibre-reinforced film. Also automatic or manual perforation of the fibre-reinforced film is possible prior to or after any optional coating.

The fibre-reinforced film according to the present invention is useful for packaging various food products such as meat, fish, poultry, vegetable, cheese, or cheese type products. Said fibre-reinforced film is particularly suitable for packaging meat products to be cooked or smoked such as hams.

The fibre-reinforced film of the invention is also suitable for flavouring and colouring of food products. Various flavouring and/or colour agents optionally present in the impregnating solution, such as smoke flavour and caramel colour, are transferred from the film to the food product for instance during cooking. Superior permeability of the fibre-reinforced film also allows for the transfer of flavouring and/or colour agents to the food product through the film from outside, such as during a conventional smoking process.

The fibre-reinforced film of the invention is also very suitable for the production of specialty products, such as transfer of solid particles such as seasonings to the surface of the food product in a mould. Then solid particles are attached to the fibre-reinforced film by means of the alginate, or an adhesive acceptable for food product applications such as a casein glue prior to final drying of the film. Said solid particles may include e.g. various peppers, paprika, mustard seeds, or breadcrumbs. Alternatively, said solid particles may be sprinkled on the surface of the food product to be packaged in the fibre-reinforced film prior to wrapping the product with said film. The solid particles are fastened on the surface of the food product during cooking.

A food product packaged in a fibre-reinforced film of the present invention may be inserted in a net, which prevents the film from opening. The fibre-reinforced film is sufficiently elastic to allow for the food product emulsion to bulge through the net meshes, thus yielding a beautiful, clearly visible net pattern on the product. The net may be easily removed from the fibre-reinforced film. Due to the impregnation treatment and resistance properties, also the film itself may be easily peeled from the surface of the food product. The food product may be processed such as sliced, thus providing the slices with wavy edges, corresponding to the net pattern.

In addition to the advantages achieved by the fibre-reinforced film of the invention in relation to the use thereof, also significant economic benefits are achieved. Typically in a paper roll supplied by a paper mill, the paper in the middle part making about 70% of the roll, so-called CC (center cut) grade paper, has a very precise calibre, whereas the remaining terminal parts of the roll, so-called EC (edge cut) grade paper, has a poorer calibre precision. For tubular fibre-reinforced food casings, the CC paper is clearly the preferable option to obtain a casing functioning properly in various applications, and accordingly, it is difficult to find any use for as much as about 30% of the paper starting material of a plant producing tubular fibrous casings. However, said EC grade paper is fully adequate to be used for the fibre-reinforced films of the present invention, and thus also those parts of the paper roll normally unsuitable as starting materials may be utilized.

### EXAMPLES

### Example 1

### Increase of Wet Strengths by Impregnation Treatment

An impregnating solution containing 4% of Na alginate Manucol LD, 11% by weight of glycerol, 0.2% of Polysorbate 80 emulgator, and water, was prepared. Impregnating solutions were applied with a plastic knife on the surfaces of abaca fibre paper sheets lying on a flat surface, having basis weights of 15, 17 and 23 g/m², to fully impregnate the paper sheets. The excess impregnating solution was removed by wiping with the plastic knife. Calcium chloride solution, 5% by weight, was sprayed on both surfaces of the paper sheets, followed by an immediate skin formation on the sheets. The sheets were dried, and wet strengths in longitudinal and crosswise directions were determined. The results are presented in the Table below. Weight gains effected by the treatment for the paper sheets having basis weights of 15, 17 and 23 g/m², were discovered to be 211%, 219%, and 168%, respectively.

TABLE
Wet strengths in longitudinal and crosswise directions of untreated
and treated paper sheets having different basis weights.

| Wet strengths in longitudinal | Basis weight | Basis weight | Basis weight |
|---|---|---|---|
| and crosswise directions | 15 g/m² | 17 g/m² | 23 g/m² |
| Untreated paper, longitudinal | 413 | 360 | 636 |
| direction N/m | | | |
| Treated paper, longitudinal | 601 | 453 | 700 |
| direction N/m | | | |
| Increase of the wet strength, | 46% | 26% | 10% |
| longitudinal direction | | | |
| Untreated paper, crosswise | 386 | 308 | 498 |
| direction N/m | | | |
| Treated paper, crosswise | 471 | 378 | 558 |
| direction N/m | | | |
| Increase of the wet strength, | 22% | 23% | 12% |
| crosswise direction | | | |

### Example 2

### Production of Smoked Hams

An impregnating solution containing 2.5% of Na alginate Manugel GHB, 10% by weight of glycerol, and water, was prepared. The impregnating solution was applied with a plastic knife on the surfaces of paper sheets lying on a flat surface to fully impregnate the paper sheets. The paper sheets were cut from an EC grade abaca fibre paper (Ahlstrom Oy, Finland), having a basis weight of 15 g/m². The excess impregnating solution was removed by wiping with the plastic knife. Calcium chloride solution, 5% by weight, was sprayed on both surfaces of the paper sheets, followed by an immediate skin formation on the sheets, and finally, the sheets were dried.

The fibre-reinforced sheets prepared above were wetted with water, and adjusted on a stuffing device in the form of a bag. Emulsion of crossed ham macerated overnight was stuffed in the sheets, followed by wrapping in nets, and cooking by smoking in a conventional manner. After cooking, the net and the fibre-reinforced film were removed from the ham. Both the net and the film could be easily peeled from the ham, without residues of the film remaining on the ham, or without any ham sticking on the peeled film. The appearance of the ham was as desired, i.e. the colour was even and intense, and the net pattern was clearly visible.

1-26. (canceled)

27. Fibre-reinforced film comprising a paper-reinforced alginate film containing a polyhydric alcohol, characterized in that the basis weight of the paper is between 8 and 40 g/m², the proportion of paper is no more than 70% by weight of the fibre-reinforced film, and the alginate film is formed by cross-linking alginic acid or a water-soluble salt thereof used to impregnate the paper with an aqueous solution of a salt having bivalent cations to give an alginate film covering the whole paper across the total thickness thereof.

28. Fibre-reinforced film according to claim 27, characterized in that the basis weight of the paper is between 12 and 20 g/m².

29. Fibre-reinforced film according to claim 27, characterized in that said paper comprises at least one hemp fibre and optionally at least one woodpulp fibre, said paper preferably comprising abaca fibre or a mixture of abaca fibre and chemical pulp from pine, the paper particularly preferably comprising abaca fibre.

30. Fibre-reinforced film according to claim 27, characterized in that the proportion of paper is up to 50%, preferably up to 40%, by weight.

31. Fibre-reinforced film according to claim 27, characterized in that said water-soluble salt of the alginic acid is sodium, potassium, or ammonium alginate, preferably sodium alginate, whereas the salt with bivalent cations is calcium chloride, calcium acetate, or calcium stearate, preferably calcium chloride.

32. Fibre-reinforced film according to claim 27, characterized in that said fibre-reinforced film comprises between 1 and 40%, preferably between 15 and 25%, and particularly preferably from 18 to 22%, by weight, of the polyhydric alcohol.

33. Fibre-reinforced film according to claim 27, characterized in that said polyhydric alcohol is selected from the group consisting of glycerol, sorbitol, mannitol, galactitol, arabitol, erythritol, xylitol, and mixtures thereof, the polyhydric alcohol being preferably glycerol.

34. Fibre-reinforced film according to claim 27, characterized in that said fibre-reinforced film comprises flavouring and/or colouring agents, coatings, perforations, or solid particles like peppers, paprika, mustard seeds or breadcrumbs.

35. Fibre-reinforced film according to claim 27, characterized in that said fibre-reinforced film further comprises an emulgator.

36. Process for producing a fibre-reinforced film, characterized in that the process comprises:
impregnating a paper having basis weight between 8 and 40 g/m² with an impregnating solution comprising alginic acid or a water-soluble salt thereof, a polyhydric alcohol, and water,
removing the excess impregnating solution,
treating both surfaces of the impregnated paper with an aqueous solution of a salt comprising bivalent cations for cross-linking the alginic acid or the water-soluble salt thereof, and
drying the paper thus treated,
thus obtaining a fibre-reinforced film comprising a paper-reinforced alginate film containing polyhydric alcohol, wherein the proportion of paper is no more than 70% by weight of the fibre-reinforced film, and the alginate film covers the whole paper across the total thickness thereof.

37. Process according to claim 36, characterized in that the basis weight of the paper is between 12 and 20 g/m².

38. Process according to claim 36, characterized in that said paper comprises at least one hemp fibre and optionally at least one woodpulp fibre, said paper preferably comprising abaca fibre or a mixture of abaca fibre and chemical pulp from pine, the paper particularly preferably comprising abaca fibre.

39. Process according to claim 36, characterized in that said water-soluble salt of the alginic acid is sodium, potassium, or ammonium alginate, preferably sodium alginate.

40. Process according to claim 36, characterized in that the concentration of the polyhydric alcohol in the impregnating solution ranges from 5 to 20%, by weight.

41. Process according to claim 36, characterized in that said polyhydric alcohol is selected from the group consisting of glycerol, sorbitol, mannitol, galactitol, arabitol, erythritol, xylitol, and mixtures thereof, the polyhydric alcohol being preferably glycerol.

42. Process according to claim 36, characterized in that said impregnating solution comprises flavouring and/or colouring agents.

43. Process according to claim 36, characterized in that said impregnating solution further comprises an emulgator.

44. Process according to claim 36, characterized in that said salt with bivalent cations is calcium chloride, calcium acetate, or calcium stearate, preferably calcium chloride, the concentration thereof in the aqueous solution being between 1 and 10%, preferably between 4 and 8%, by weight.

45. Process according to claim 36, characterized in that said paper to be impregnated is in the form of sheets.

46. Process according to claim 36, characterized in that the paper either in the form of a web or bent to a tubular form is impregnated by passing into a bath containing the impregnating solution, or by spraying the impregnating solution at least on one surface of the paper, followed by removing the excess impregnating solution, spraying an aqueous solution of a salt with bivalent cations on both surfaces of the paper, and finally drying and reeling the web to form a roll, or cutting to give sheets.

47. Process according to claim 36, characterized in that said fibre-reinforced film is coated or perforated.

48. Process according to claim 36, characterized in that solid particles such as various peppers, paprika, mustard seeds, or breadcrumbs are attached to the fibre-reinforced film by means of the alginate or an adhesive acceptable for food product applications.

49. Use of a fibre-reinforced film according to claim 27, or produced with the process for producing a fibre-reinforced film, characterized in that the process comprises:
impregnating a paper having basis weight between 8 and 40 g/m² with an impregnating solution comprising alginic acid or a water-soluble salt thereof, a polyhydric alcohol, and water,
removing the excess impregnating solution,
treating both surfaces of the impregnated paper with an aqueous solution of a salt comprising bivalent cations for cross-linking the alginic acid or the water-soluble salt thereof, and
drying the paper thus treated,
thus obtaining a fibre-reinforced film comprising a paper-reinforced alginate film containing polyhydric alcohol, wherein the proportion of paper is no more than 70% by weight of the fibre-reinforced film, and the alginate film covers the whole paper across the total thickness thereof, for packaging various food products such as meat, fish, poultry, vegetable, cheese, or cheese type products, and particularly for packaging meat products to be cooked or smoked.

50. Use according to claim 49, wherein said fibre-reinforced film is wetted with water or optionally with an aqueous solution containing flavouring and/or colouring agents prior to packaging said food product.

51. Use according to claim 49, wherein solid particles such as various peppers, paprika, mustard seeds, or breadcrumbs are sprinkled on the food-contacting surface of the fibre-reinforced film prior to packaging said food product in the fibre-reinforced film.

52. Use according to claim 49, wherein the food product packaged in the fibre-reinforced film is covered by a net, thus providing a net pattern on the food product, said net pattern being clearly visible after removal of the net and the fibre-reinforced film.
